(19) United States
(12) Patent Application Publication
(10) Pub. No.: US 2012/0057131 A1
(43) Pub. Date: Mar. 8, 2012

(54) FULL PARALLAX THREE-DIMENSIONAL DISPLAY DEVICE

(76) Inventors: Haifeng Li, Zhejiang Province (CN); Shuai Li, Zhejiang Province (CN); Xu Liu, Zhejiang Province (CN); Yifan Peng, Zhejiang Province (CN)

(21) Appl. No.: 13/143,834

(22) PCT Filed: Jul. 6, 2010
(86) PCT No.: PCT/CN10/75004

§ 371 Date: Jul. 8, 2011

(30) Foreign Application Priority Data
Apr. 16, 2010 (CN) 201010148532.1

(51) Int. Cl. G02B 27/22; G03B 21/00

(52) U.S. Cl. 353/7

(57) ABSTRACT

The present invention discloses a full parallax three-dimensional display device. It comprises a projector array and an orthogonal cylinder raster screen. The orthogonal cylinder raster screen comprises the first cylinder raster and the second cylinder raster. The projector array and the orthogonal cylinder raster screen are put in order. The projector array projects images on the orthogonal cylinder raster screen. The raster directions of the first cylinder raster and the second cylinder raster of the orthogonal cylinder raster screen are parallel to the x-axis and the y-axis, respectively. The advantage of the present invention is that it can generate 3D images of high image resolution and high view-field resolution. The extremely tiny view field intervals can bring completely continuous and jumping-free 3D perception for the viewer, reduce the fatigue caused by discontinuous view field in conventional 3D display, and achieve full parallax 3D display including horizontal parallax and vertical parallax.

### TECHNICAL FIELD

The present invention relates to a three-dimensional display device, specifically a full parallax three-dimensional display device.

### BACKGROUND ART

The Three-dimensional (3D) display intends to bring visual perception of depth to the viewer through various methods, making the information of the third dimension available for the viewer naturally or unnaturally, which differentiates it from two-dimensional (2D) display. Whether the acquisition of depth information is natural or unnatural means real 3D or unreal 3D (or quasi-3D) for the viewer. Up to now, 3D display technology has achieved a great number of results. These results can be classified as holographic 3D display, volumetric 3D display and stereo 3D display, etc. The holographic technology can generate very realistic spatial effect, but it requires high-resolution spatial light modulator and super-high-speed data processing system in terms of dynamic display, which extremely limits its development and stops it from being well used practically. The volumetric 3D display and stereoscopic 3D display both have relatively good display device appearing on the market currently, however, display devices based on these two methods mostly depend on turning the screen to achieve full-field viewing, therefore the structure of the display device is relatively complex and the cost is also relatively expensive.

The current stereoscopic 3D display has shortcomings such as low image resolution, narrow view field and discontinuous view field. The advantage of the present invention is that it can generate 3D images with high image resolution and high view field resolution. The extremely tiny view field intervals can bring completely continuous and jumping-free 3D perception for the viewer, reduce the fatigue caused by discontinuous view field in conventional 3D display, and achieve full parallax 3D display including horizontal parallax and vertical parallax.

### TECHNICAL PROBLEM

The purpose of the present invention is to overcome the deficiency of the current technology and provide a full parallax three-dimensional display device.

### TECHNICAL SOLUTION

The full parallax three-dimensional display device comprises a projector array and an orthogonal cylinder raster screen, and the orthogonal cylinder raster screen comprises a first cylinder raster and a second cylinder raster; the projector array and the orthogonal cylinder raster screen are placed in a serial order; the projector array projects images on the same position of the orthogonal cylinder raster screen, and the raster directions of the first and the second cylinder raster of the orthogonal cylinder raster screen are parallel to the x-axis and the y-axis, respectively.

The horizontal distance Dx and the projecting distance Lp of the projector array, have the following relation with the raster distance dy and focal length fy of the second cylinder raster:

Dx/Lp=dy/fy.

The vertical distance Dy and the projecting distance Lp of the projector array, have the following relation with the raster distance dx and focal length fx of the first cylinder raster:

Dy/Lp=dx/fx.

The projector array is an array comprised of multiple projectors, or comprised of a two-dimensional display and multiple lenses.

The two-dimensional display is LCD, PDP, LED, CRT or projector.

### ADVANTAGEOUS RESULTS

The advantage of the present invention is that it can generate 3D images of high image resolution and high view-field resolution. The extremely tiny view field intervals can bring completely continuous and jumping-free 3D perception for the viewer, reduce the fatigue caused by discontinuous view field in conventional 3D display, and achieve full parallax 3D display including horizontal parallax and vertical parallax.

### DESCRIPTION OF THE DRAWINGS

The following is a further description of the present invention with drawings and embodiment examples.

FIG. 1 shows the structure of the full parallax 3D display device.

FIG. 2 shows the relation between the projector interval and the scattering property of the orthogonal cylinder raster screen.

FIG. 3(a) shows the relation between the focal length of the cylinder lens and the scattering angle.

FIG. 3(b) shows the working principle of the orthogonal cylinder raster screen.

FIG. 4 shows the working principle of the full parallax 3D display device.

FIG. 5 shows a view point viewing effect.

In the above figures: the projector array is marked with 1, the orthogonal cylinder raster screen is marked with 2, the small area is marked with 3, the first cylinder raster is marked with 4, the second cylinder raster is marked with 5.

### EMBODIMENTS OF THE INVENTION

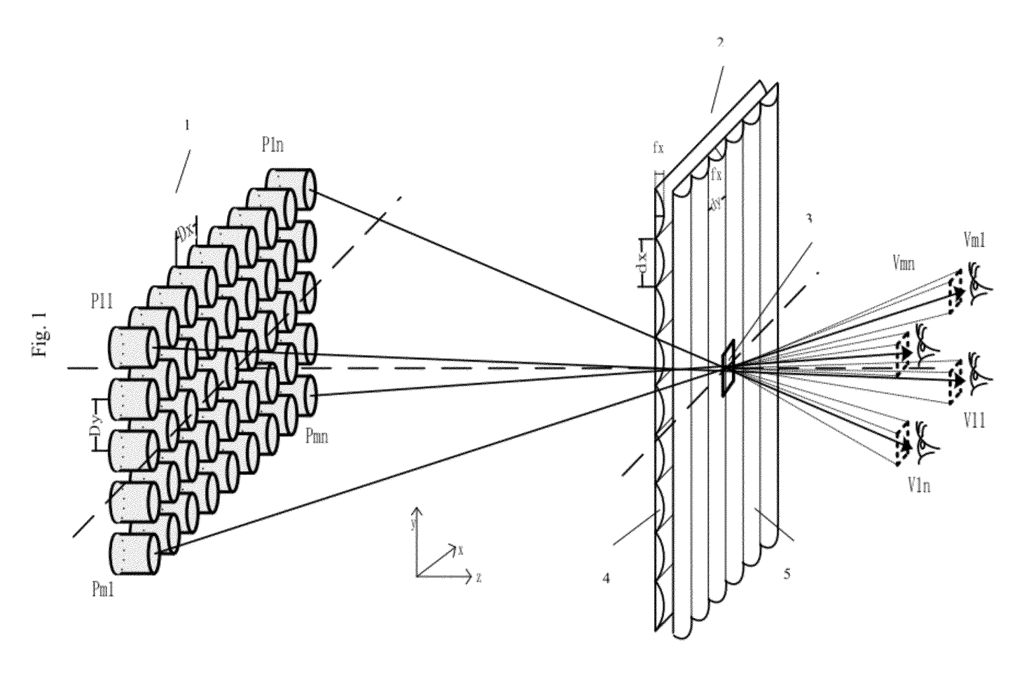

As shown in FIG. 1, the full parallax 3D display device comprises the projector array 1, and the orthogonal cylinder raster screen 2. The orthogonal cylinder raster screen 2 comprises the first cylinder raster 4, and the second cylinder raster 5. The projector array 1 and the orthogonal cylinder raster screen 2 are placed in a serial order. The projector array 1 projects images on the same position of the orthogonal cylinder raster screen 2. The raster directions of the first cylinder raster 4 and the second cylinder raster 5 of the orthogonal cylinder raster screen 2 are parallel to the x-axis and the y-axis, respectively.

The horizontal distance Dx and the projecting distance Lp of the projector array 1, have the following relation with the raster distance dy and focal length fy of the second cylinder raster 5:

Dx/Lp=dy/fy.

The vertical distance Dy and the projecting distance Lp of the projector array 1, have the following relation with the raster distance dx and focal length fx of the first cylinder raster 4:

Dy/Lp=dx/fx.

The projector array 1 is an array comprised of multiple projectors (Pll-Pmn), or comprised of a two-dimensional (2D) display and multiple lenses. The 2D display is LCD, PDP, LED, CRT or projector.

The projectors Pll-Pmn are arranged into m rows and n columns. They each project to the orthogonal cylinder raster screen. Because the orthogonal cylinder raster screen has a unique scattering property, several viewpoints Vll-Vmn are formed respectively on the right side of the screen. If one takes the small area 3 in the orthogonal cylinder raster screen as an example, different images can be seen at different viewpoints Vll-Vmn. The complete image seen at each viewpoint is joined together by small pieces of image projected by each projector. Hence the respected view of the 3D object at each viewpoint can be seen at different viewpoints. The image at each viewpoint changes continuously, providing horizontal and vertical parallax for the viewer, so as to form 3D perception.

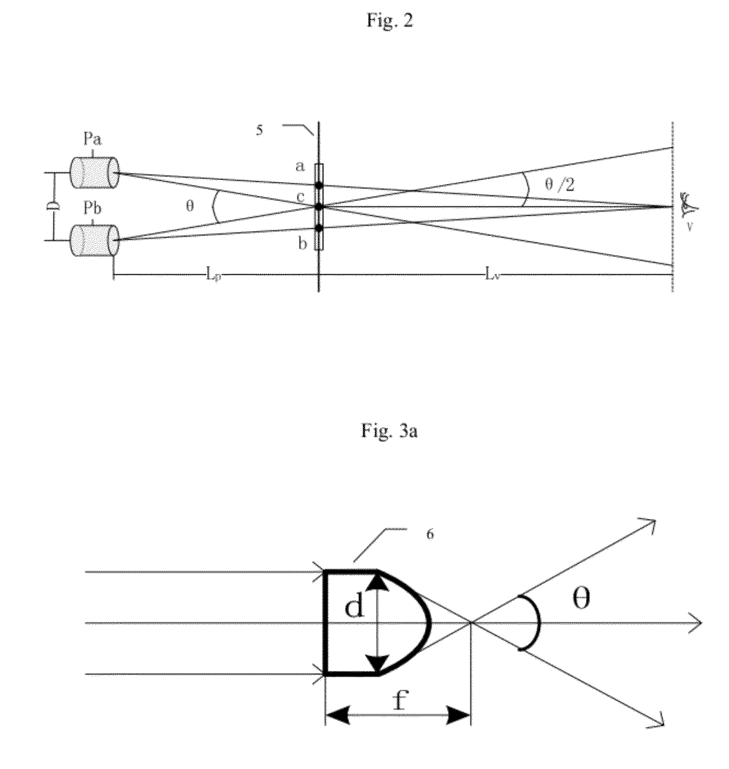

As shown in FIG. 2, two projectors Pa and Pb, whose horizontal distance is D, each project images to the second cylinder raster 5. The scattering property of the second cylinder raster required by the device is decided by the distance D and projecting distance Lp. Compared to the projector distance Lp and viewing distance Lv, the exit pupil of the projector and the pupil of viewer's eyes can be seen as one point. If the scattering angle θ of the second cylinder raster is very small, theoretically only two point images a and b from projector Pa and Pb respectively can be observed from point V. If the scattering angle θ of the second cylinder raster is increased, the two point images observed will expand to two block images. When the scattering angle increase to 2*arctg(D/2Lp), the two block images from projector Pa and Pb are precisely joined together at point c, forming a wider image. The description here only takes horizontal projectors as an example. The vertical case has the same principle.

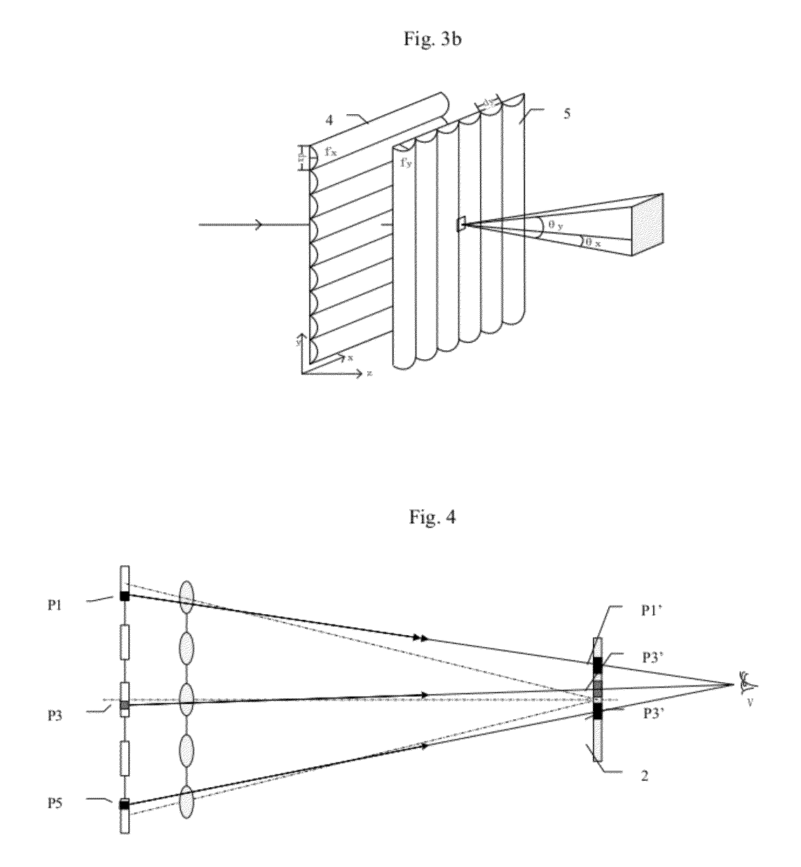

As shown in FIG. 3(a), cylinder lens 6 has caliber d, focal length f. Namely, the cylinder raster has the raster distance d and the focal length f. The cylinder raster consists of a great number of tiny cylinder lenses. The scattering property of the cylinder raster can be controlled by adjusting the raster distance d and focal length f of the cylinder raster. The raster distance d of the cylinder raster can be omitted compared to projecting distance Lp. Therefore, the light beams arriving at a single cylinder lens 6 is approximately parallel. So the scattering angle of the cylinder raster can be expressed as θ=2*arctg(d/2f), which is, f=d/(2*tg(θ/2)). To obtain a certain scattering angle θ, we just have to adjust the raster distance d and the focal length f.

As shown in FIG. 3(b), orthogonal cylinder raster screen 2 comprises the first cylinder raster 4 and the second cylinder raster 5, and the raster directions of the first cylinder raster 4 and the second cylinder raster 5 are parallel to x-axis and y-axis, respectively.

By adjusting the raster distance dx and focal length fx of the first cylinder raster 4, one can control the vertical scattering angle θy of the orthogonal cylinder raster screen 2. By adjusting the raster distance dy and focal length fy of the second cylinder raster 5, one can control the horizontal scattering angle θx of the orthogonal cylinder raster screen 2. In this way the orthogonal cylinder raster screen transform a incoming parallel light beam into a pyramid beam with horizontal and vertical scattering angles θx and θy, respectively.

As shown in FIG. 4, the complete image observed at any viewpoint is joined together by pieces of images individually projected by each projector. By the same principle, the image going into each projector is also joined together by image pieces, which are from the pictures obtained from shooting 3D objects from different viewpoints.

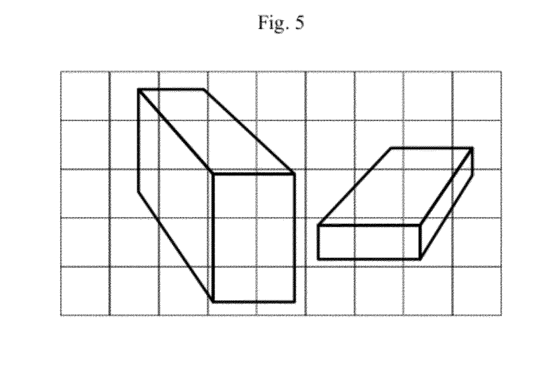

As shown in FIG. 5, observing the 3D display device from a viewpoint, the complete view is joined together by pieces of small images. Each small image corresponds to a projector in the projector array.

1. A full parallax three-dimensional display device, which comprising a projector array (1) and a orthogonal cylinder raster screen (2), and the orthogonal cylinder raster screen (2) comprises a first cylinder raster (4) and a second cylinder raster (5); the projector array (1) and the orthogonal cylinder raster screen (2) are placed in a serial order; the projector array(l) projects images on the same position of the orthogonal cylinder raster screen (2), and the raster directions of the first cylinder raster (4) and the second cylinder raster (5) of the orthogonal cylinder raster screen (2) are parallel to the x-axis and the y-axis, respectively.

2. The full parallax three-dimensional display device of claim 1, wherein the horizontal distance Dx and the projecting distance Lp of the projector array (1), have the following relation with the raster distance dy and focal length fy of the second cylinder raster (5):
Dx/Lp=dy/fy.

3. The full parallax three-dimensional display device of claim 1, wherein the vertical distance Dy and the projecting distance Lp of the projector array (1), have the following relation with the raster distance dx and focal length fx of the first cylinder raster (4):
Dy/Lp=dx/fx.

4. The full parallax three-dimensional display device of claim 1, wherein the projector array (1) is an array comprised of multiple projectors, or comprised of a two-dimensional display and multiple lenses.

5. The full parallax three-dimensional display device of claim 4, wherein said two-dimensional display is LCD, PDP, LED, CRT or projector.
